(19) United States
(12) Patent Application Publication
(10) Pub. No.: US 2026/0053170 A1
(43) Pub. Date: Feb. 26, 2026

(54) FREEZE DRIED ANIMAL FOOD COMPOSITIONS AND METHODS OF MAKING AND USING

(71) Applicant: Further Foods, Inc., Wilmington, DE (US)

(72) Inventors: Joshua Errett, Oakland, CA (US); Jonathan Cruz, Cobb, CA (US)

(73) Assignee: Further Foods, Inc., Wilmington, DE (US)

(21) Appl. No.: 19/106,137

(22) PCT Filed: Aug. 15, 2023
(86) PCT No.: PCT/US2023/030287

§ 371 Date: Feb. 24, 2025

Related U.S. Application Data
(60) Provisional application No. 63/373,187, filed on Aug. 22, 2022.

(51) Int. Cl. A23K 10/16; A23K 10/30; A23K 20/147; A23K 40/20; A23K 50/42

(52) U.S. Cl. CPC A23K 10/16; A23K 10/30; A23K 20/147; A23K 40/20; A23K 50/42

(57) ABSTRACT

Solid frecze-dried animal food compositions and methods of preparing and using the animal food compositions are disclosed. The animal food compositions comprise a yeast product. an Aspergillus sp. product, and essential nutrients.

### CROSS-REFERENCE TO RELATED APPLICATIONS

This application is a national stage application of International Patent Application No. PCT/US2023/030287, filed on Aug. 15, 2023, which claims priority to U.S. Provisional Appl. Ser. No. 63/373,187, filed Aug. 22, 2022, the entire disclosure of which is incorporated herein by reference.

### FIELD OF THE INVENTION

The present disclosure provides a nutritionally complete freeze-dried animal food composition and methods of producing and using the food compositions.

### BACKGROUND OF THE INVENTION

Currently available animal foods intended for cats and dogs comprise animal products as dogs and cats require the high protein content and other essential nutrients normally found in animal-based foods. However, animal-based foods can be problematic because of the detrimental environmental impact they produce during production. Such animal products also have shelf-life stability issues, inconvenient supply chain mechanics and inconsistent ingredient integrity, among other issues.

Accordingly, there is a need for an animal food product comprising an animal-free alternative protein source, is not detrimental to the environment, is shelf stable, and which utilizes ingredients having good supply chain mechanics.

### SUMMARY OF THE INVENTION

The present disclosure is based in part on the surprising discovery by the inventor of animal food compositions that are animal protein-free, yet shelf-stable, and nutritionally suitable and palatable to carnivorous animals, including cats. Before the instant disclosure, there were no animal-free animal foods that were shelf-stable and nutritionally suitable and highly palatable to carnivorous animals, such as cats. The animal food compositions of the present disclosure are solid food products capable of retaining their shape during storage and transport, that liquifies when ingested and is also highly palatable.

The present disclosure provides an animal food composition comprising at least about 15%, about 16%, about 17%, about 18%, about 19%, about 20%, about 21%, about 22%, about 23%, about 24%, about 25%, about 96%, about 27%, about 28%, about 29% or about 30% yeast product and at least about 1%, about 2%, about 3%, about 4%, about 5%, about 6%, about 7%, about 8%, about 9%, about 10%, about 11%, about 12%, about 13%, about 14% or about 15% Aspergillus sp. product. In certain embodiments the animal food composition comprises less than 1%, less than 0.9%, less than 0.8%, less than 0.7%, less than 0.6%, less than 0.5%, less than 0.4%, less than 0.3%, less than 0.2%, less than 0.1%, or less of protein derived from an animal source. In some embodiments the animal food composition comprises less than 1%, less than 0.9%, less than 0.8%, less than 0.7%, less than 0.6%, less than 0.5%, less than 0.4%, less than 0.3%, less than 0.2%, less than 0.1%, or less of protein derived from mammalian or insect sources. In other embodiments the animal food composition comprises a nutritional profile similar to a meat-based animal food.

In particular embodiments the yeast product is a deactivated yeast. In other embodiments the yeast product comprises Saccharomyces cerevisiae. In yet other embodiments the yeast product is dried yeast. In still other embodiments the yeast product and the Aspergillu ssp. product are powdered forms of the yeast product and the Aspergillus sp. product. In additional embodiments the Aspergillus sp. product comprises Aspergillus niger. In certain embodiments the Aspergillus sp. product is a koji mold comprising an Aspergillus sp. In some embodiments the animal food composition comprises at least about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29% or about 30% of protein content from the yeast product and the Aspergillus sp. product. In other embodiments the animal food composition comprises about 15% of the protein content from the yeast product and the Aspergillus sp. product.

In various embodiments the animal food composition comprises a cylindrical shape, a rectangular shape, a cuboid shape, a triangular shape, a circular shape, an elliptical shape, a polygonal shape, a polyhedral shape, or an irregular shape. In certain embodiments the animal food composition comprises a form and size suitable for consumption by a cat. In some embodiments the animal food composition suitable for consumption by a cat comprises a length of about ½ inch, width of about ½ inch, and a thickness of about ½ inch, or a length of about ⅜, about ¼ inch or about \vec{1/8} inch, a width of about ⅜ inch, about ¼ inch or about ⅛ inch, and a thickness of about ⅜ inch, bout ¼ inch or about ⅛ inch. In other embodiments the animal food composition suitable for consumption by a cat comprises different lengths, widths and thicknesses. In particular embodiments the animal food composition suitable for consumption by a cat comprises a cylindrical shape.

In other embodiments the animal food composition comprises a form and size suitable for consumption by a dog. In yet other embodiments the animal food composition suitable for consumption by a dog comprises a length of about 1 inch, a width of about ½ inch, and a thickness of ⅜ inch, or a length of about ⅞ inch, about ¾ inch, about ⅝ inch, about ½ inch, about ⅜ inch or about ¼ inch, a width of about ⅜ inch or about ¼ inch, and a thickness of about ¼ inch or about ⅛ inch. In some embodiments the animal food composition suitable for consumption by a dog comprises the same length, width and thickness. In still other embodiments the animal food composition suitable for consumption by a dog comprises a rectangular or domino shape.

The present disclosure also provides a method of preparing an animal food composition, the method comprising forming a paste comprising a yeast product and an Aspergillus sp. product by hydrating a dry yeast product and a dry Aspergillus sp. product with a fluid, shaping the paste to form a shaped paste, and frecze-drying the shaped paste. In certain embodiments the ratio of the dry yeast product and the dry Aspergillus sp. product to the fluid is about 10:1, about 9:1, about 8:1, about 7:1, about 6:1, about 5:1, about 4:1, about 3:1, about 2:1;about 1:1, about 1:2, about 1:3, about 1:4, about 1:5, about 1:6, about 1:7, about 1:8, about 1:9 or about 1:10. In some embodiments the fluid is water, an oil, such as a vegetable or mineral oil, or water in combination with an oil or one or more other suitable fluids.

In certain embodiments of the method, the shaped paste is in a form suitable for consumption by an animal. In other embodiments of the method, the shaped paste is in a form suitable for further processing. In yet other embodiments of the method, the shaped paste is formed into a sheet. In further embodiments, the method comprises cutting the sheet into strips. In some embodiments the sheet is cut before freeze-drying.

In certain embodiments of the method, the shaped paste is frozen to a temperature ranging from about −30° F. to about 10° F. In various embodiments of the method, the shaped paste is frozen to a temperature ranging from about −20° F. to about −10° F., from about −10° F. to about 10° F., from about −5° F. to about 10° F., from about 0° F. to about 10° F., from about −30° F. to about 5° F., from about −30° F. to about 0° F., from about −30° F. to about −10° F., from about −30° F. to about −20° F., from about −20° F. to about 5° F., from about −10° F. to about 0° F., or a temperature of about −30° F., about −25° F., about −20° F., about −15° F., about −10° F., about −5° F., about 0° F., about 5° F. or about 10° F.

In additional embodiments, the method further comprises tempering the frozen shaped paste to a temperature ranging from about 0° F. to about 30° F. In some embodiments, the method further comprises tempering the frozen shaped paste to a temperature ranging from about 5° F. to about 30° F., from about 10° F. to about 30° F., from about 15° F. to about 30° F., from about 20° F. to about 30° F., from about 25° F. to about 30° F., from about 0° F. to about 25° F., from about 0° F. to about 20° F., from about 0° F. to about 15° F., from about 0° F. to about 10° F., from about 0° F. to about 5° F., from about 5° F. to about 25° F., from about 10° F. to about 20° F., or about 0° F., about 5° F., about 10° F., about 15° F., about 20° F., about 25° F. or about 30° F.

The present disclosure additionally provides a method of feeding an animal food composition to an animal, the method comprising feeding an animal food composition comprising at least about 25% yeast product and at least about 1% Aspergillus sp. product to the animal, wherein the animal food composition maintains or improves gut health and immunity. In certain embodiments the animal food composition provides all the nutritional needs of the animal.

### DETAILED DESCRIPTION

The present disclosure is based in part on the surprising discovery of animal food compositions that are animal protein-free, yet nutritionally complete and palatable to dogs. Before the instant invention was made, there were no animal-free dog foods that were nutritionally complete and highly palatable. The dog food of the present disclosure is a solid food product capable of retaining its shape during storage and transport, that liquifies when ingested and is also highly palatable.

The animal food compositions of the instant disclosure use environmentally friendly and sustainable ingredients having good supply chain mechanics. The animal food of the instant disclosure provides a protein source comprising similar nutrients and/or levels of nutrients as traditional animal-based meat products with additional beneficial functionality. Importantly, the animal food comprises a high content of high-quality bioavailable functional proteins and other essential nutrients such as B vitamins, which are essential for gut health and immunity. Further, amino acids such as glutamate and threonine work as fuel for the enterocytes in the gastrointestinal tract while supporting the mucosal membrane and normal physiological functioning. The animal food supports cognitive, arterial and heart health. The array of amino acids, including arginine, leucine, isoleucine and valine of the animal food product works to support the animal's gut, arterial, heart and cognitive health.

### I. Composition

One aspect of the instant disclosure encompasses a solid freeze-dried animal food composition. The animal food composition comprises a yeast or freeze-dried yeast product, an Aspergillus sp. product, various plant, fruit and plant—and fruit-based ingredients (for example kale, squash, peanuts, banana, nuts, seeds, and others—see Examples below), and essential nutrients required for animals. The animal food composition is nutritionally complete and can be free of ingredients other than the yeast product, the Aspergillus sp. product, and the essential nutrients. The animal food products can also be meat protein-free, animal protein-free, insect protein-free, mammalian protein-free or free of protein derived from Kingdom Animalia sources. In some aspects, the yeast product and the Aspergillus sp. product are dry powdered forms of the yeast product and the Aspergillus sp. product.

The animal can be a human, a livestock animal, a companion animal, a lab animal, or a zoological animal. In one aspect, the subject can be a rodent, e.g., a mouse, a rat, a guinea pig, etc. Non-limiting examples of suitable livestock animals may include pigs, cows, horses, goats, sheep, llamas and alpacas. As used herein, a “zoological animal” refers to any animal that may be found in a zoo. Such animals may include, but are not limited to, non-human primates, large cats, wolves, and bears. Non-limiting examples of a laboratory animal may include rodents, canines, felines, and non-human primates. In some aspects, the subject is a human subject. In some aspects, the animal is an obligate carnivorous animal. In some aspects, the animal is a companion animal. Non-limiting examples of companion animals may include pets such as dogs, cats, rabbits, guinea pigs, pot bellied pigs, and birds. In some aspects, the animal is a dog. In other aspects, the animal is a cat.

The animal food compositions of the instant disclosure can be of any size and shape suitable for administration to an animal. It will be recognized that the size and shape of the animal food can and will vary depending on the animal. Accordingly, the animal food products can be of any size and shape suitable for consumption by the animal. The animal food product can have regular shapes such as a cuboid, a conical, a cylindrical, a rectangular, a polygonal, or a disc shape, or shaped in the form of “kisses.” Alternatively, the animal food compositions of the instant disclosure can be formed into irregular shapes, or shapes that can provide some additional benefits to the animal upon chewing. For instance, the animal food products can include protrusions to aid in cleaning the animal's teeth. In some aspects, the animal food composition of the instant disclosure is a cuboid (including a cube or a rectangular cuboid), triangular, circular, elliptical, polyhedral, and irregular shapes. In some aspects the animal food product comprises a cuboid shape suitable for ingestion by the animal.

In some aspects, the animal food product comprises a form and size suitable for consumption by a dog. For instance, the animal food composition can be a polygon or domino-shape comprising a length ranging from about ⅛ inch long to about 1 inch long or more, a width of about ⅛ inch to about ½ inch or more, and a thickness of about ⅛ inch to about ⅜ inch or more. In some aspects, the animal food composition is a cuboid comprising a length, width and thickness of about ½ inch, about ⅝ inch or about ¾ inch.

In some aspects, the animal food composition comprises a form and size suitable for consumption by a cat. Taste preferences and dict palatability (taste, odor, shape, mouthfeel and texture) in cats has been studied (see, e.g., Yavuz Pekel, et al., J. Appl. Anim. Res. 48:281-292, 2020, and afbinternational.com/wp-content/uploads/2022/09/Kibble-Shape-Effects-Palatability_WP_2020.pdf). For instance, the animal food product can be a cylinder comprising a length ranging from about ⅛ inch long to about ½ inch, a width of about ⅛ inch to about ½ long, and a thickness of about ⅛ inch to about ½ inch. In some aspects, the animal food product is a cuboid comprising a length, width and thickness of about ¼ inch, about ⅜ inch or about ½ inch.

### (a) Yeast Product

The animal food compositions of the instant disclosure comprise a yeast product. The effects of yeast products on circulating immune cells and oxidative stress markers (Wilson, et al., J. Anim. Sci. 2022 Sep. 1;100 (9): skac245. doi: 10.1093/jas/skac245), fecal characteristics, oxidative stress and blood gene expression (Wilson, et al., J. Anim. Sci. 2023, skac378, doi.org/10.1093/jas/skac378), diet digestibility, fermentative metabolites and fecal microbiota (Bastos, et al., Microorganisms 2023, 11(2), 506; doi.org/10.3390/microorganisms11020506), intestinal health (Lin, et al., Front. Vet. Sci. frontiersin.org/articles/10.3389/fvets. 2020.597939/full) have been studied in dogs, and the effects on growth performance, rumen fermentation and immune response have been studied in weaned beef calves (Ma, et al., Anim. Nutr. 7:1352-1359, 2021). The yeast product generally has nutrient specifications similar to egg products. A yeast product suitable for an animal food composition or product of the instant disclosure can comprise, without limitation, Saccharomyces bisporus, Saccharomyces boulardii, Saccharomyces cerevisiae, Saccharomyces capsularis, Saccharomyces delbrueckii, Saccharomyces fermentati, Saccharomyces lugwigii, Saccharomyces microellipsoides, Saccharomyces pastorianus, Saccharomyces rosei, Candida albicans, Candida cloaceae, Candida tropicalis, Candida utilis, Geotrichum candidum, Hansenula americana, Hansenula anomala, Hansenula wingei, or any combination thereof.

The yeast product can be any yeast or yeast-derived product provided the yeast is generally regarded as safe for use in food or medical applications. In some aspects, the product is a deactivated yeast. In some aspects, the yeast product is a powdered form of a deactivated yeast. Deactivated yeast, also called nutritional yeast, is often a strain of Saccharomyces cerevisiae that is sold commercially as a food product. It is sold in the form of yellow flakes, granules, or powder and can be found in the bulk aisle of most natural food stores. It is popular with vegans and vegetarians and may be used as an ingredient in recipes or as a condiment. Deactivated yeast is a significant source of some B-complex vitamins and contains trace amounts of several other vitamins and minerals. Sometimes deactivated yeast is fortified with vitamin B12. Deactivated yeast has a strong flavor that is described as nutty or cheesy, which makes it popular as an ingredient in cheese substitutes. It is often used by vegans in place of cheese in, for example, mashed and fried potatoes or scrambled tofu, or as a topping for popcorn. Deactivated yeast is a whole-cell inactive yeast that contains both soluble and insoluble parts. In some aspects, the yeast product of the instant disclosure is deactivated yeast in a dry powdered form.

The yeast product can be dried powdered yeast product. In some aspects, the yeast product comprises a Saccharomyces sp. yeast. In some aspects, the yeast product comprises Saccharomyces cerevisiae. In some aspects, the yeast product comprises deactivated Saccharomyces cerevisiae.

(b) Aspergillus sp. Product

The animal food compositions of the instant disclosure also comprise an Aspergillus sp. product. An Aspergillus sp. product suitable for an animal food composition of the instant disclosure can comprise, without limitation, Aspergillus acidohumus, Aspergillus acidus, Aspergillus aculeatinus, Aspergillus aculeatus, Aspergillus aeneus, Aspergillus affinis, Aspergillus alabamensis, Aspergillus albertensis, Aspergillus alliaceus, Aspergillus amazonicus, Aspergillus ambiguus, Aspergillus amoenus, Aspergillus amstelodami, Aspergillus amyloliquefaciens, Aspergillus amylovorus, Aspergillus anomalus, Aspergillus anthodesmis, Aspergillus angustatus, Aspergillus apicalis, Aspergillus appendiculatus, Aspergillus arachidicola, Aspergillus ardalensis, Aspergillus arenarius, Aspergillus arvii, Aspergillus askiburgiensis, Aspergillus asperescens, Aspergillus assulatus, Aspergillus astellatus, Aspergillus aurantiobrunneus, Aspergillus aurantiopurpureus, Aspergillus aureolatus, Aspergillus aureoterreus, Aspergillus aureus, Aspergillus auricomus, Aspergillus australensis, Aspergillus austroafricanus, Aspergillus avenaceus, Aspergillus awamori, Aspergillus baarnensis, Aspergillus baeticus, Aspergillus bahamensis, Aspergillus bertholletius, Aspergillus biplanus, Aspergillus bisporus, Aspergillus bombycis, Aspergillus botswanensis, Aspergillus brasiliensis, Aspergillus brevistipitatus, Aspergillus brevijanus, Aspergillus brevipes, Aspergillus brevistipitatus, Aspergillus bridgeri, Aspergillus brunneo-uniseriatus, Aspergillus brunneus, Aspergillus brunneoviolaceus, Aspergillus caatingaensis, Aspergillus caelatus, Aspergillus caesiellus, Aspergillus caespitosus, Aspergillus calidoustus, Aspergillus californicus, Aspergillus campestris, Aspergillus candidus, Aspergillus caninus, Aspergillus capensis, Aspergillus capsici, Aspergillus carbonarius, Aspergillus carneus, Aspergillus carlsbadensis, Aspergillus cejpii, Aspergillus cavernicola, Aspergillus cervinus, Aspergillus chevalieri, Aspergillus chinensis, Aspergillus chungii, Aspergillus cibarius, Aspergillus citrinoterreus, Aspergillus clavatoflavus, Aspergillus clavatonanicus, Aspergillus clavatus, Aspergillus cleistominutus, Aspergillus conicus, Aspergillus conjunctus, Aspergillus conversis, Aspergillus coreanus, Aspergillus coremiiformis, Aspergillus costaricensis, Aspergillus costiformis, Aspergillus creber, Aspergillus cremeus, Aspergillus cretensis, Aspergillus cristatus, Aspergillus crustosus, Aspergillus crystallinus, Aspergillus cumulatus, Aspergillus cvjetkovicii, Aspergillus deflectus, Aspergillus delacroixii, Aspergillus delicatus, Aspergillus densus, Aspergillus dentatulus, Aspergillus depauperatus, Aspergillus dessyi, Aspergillus destruens, Aspergillus digitatus, Aspergillus dimorphicus, Aspergillus diplocystis, Aspergillus discophorus, Aspergillus disjunctus, Aspergillus desertorum, Aspergillus diversus, Aspergillus dorothicus, Aspergillus dromiae, Aspergillus dubius, Aspergillus duricaulis, Aspergillus dybowskii, Aspergillus eburneocremeus, Aspergillus eburneus, Aspergillus echinosporus, Aspergillus echinulatus, Aspergillus ecuadorensis, Aspergillus effusus, Aspergillus egyptiacus, Aspergillus elatior, Aspergillus elegans, Aspergillus ellipsoideus, Aspergillus ellipticus, Aspergillus elongatus, Aspergillus equitis, Aspergillus erythrocephalus, Aspergillus eucalypticola, Aspergillus europaeus, Aspergillus falconensis, Aspergillus fasciculatus, Aspergillus felis, Aspergillus fennelliae, Aspergillus ferenczii, Aspergillus ferrugineus, Aspergillus ficuum, Aspergillus fiemonthi, Aspergillus fijiensis, Aspergillus filifera, Aspergillus fimetarius, Aspergillus fimeti, Aspergillus fischeri, Aspergillus fischerianus, Aspergillus flaschentraegeri, Aspergillus flavescens, Aspergillus flavidus, Aspergillus flavipes, Aspergillus flavofurcatus, Aspergillus flavoviridescens, Aspergillus flavus, Aspergillus floccosus, Aspergillus floridensis, Aspergillus floriformis, Aspergillus foeniculicola, Aspergillus foetidus, Aspergillus fonsecaeus, Aspergillus foutoynontii, Aspergillus foveolatus, Aspergillus fresenii, Aspergillus fructus, Aspergillus fruticans, Aspergillus fruticulosus, Aspergillus fujiokensis, Aspergillus fuliginosus, Aspergillus fulvus, Aspergillus fumaricus, Aspergillus fumigatiaffinis, Aspergillus fumigatoides, Aspergillus fumigatus, Aspergillus fumisynnematus, Aspergillus fungoides, Aspergillus funiculosus, Aspergillus fuscus, Aspergillus galapagensis, Aspergillus galeritus, Aspergillus germanicus, Aspergillus giganteus, Aspergillus gigantosulphureus, Aspergillus gigas, Aspergillus glaber, Aspergillus glabripes, Aspergillus glaucoaffinis, Aspergillus glauconiveus, Aspergillus glaucus, Aspergillus globosus, Aspergillus godfrini, Aspergillus gorakhpurensis, Aspergillus gracilis, Aspergillus granulatus, Aspergillus granulosus, Aspergillus gratioti, Aspergillus greconis, Aspergillus griseus, Aspergillus guttifer, Aspergillus gymnosardae, Aspergillus halophilicus, Aspergillus halophilus, Aspergillus helicothrix, Aspergillus hennebergii, Aspergillus herbariorum, Aspergillus heterocaryoticus, Aspergillus Aspergillus heterothallicus, Aspergillus heyangensis, Aspergillus hiratsukae, Aspergillus haitiensis, Aspergillus hollandicus, Aspergillus homomorphus, Aspergillus hordei, Aspergillus hortae, Aspergillus hortai, Aspergillus huiyaniae, Aspergillus humicola, Aspergillus humus, Aspergillus ibericus, Aspergillus igneus, Aspergillus iizukae, Aspergillus implicatus, Aspergillus incrassatus, Aspergillus indicus, Aspergillus indohii, Aspergillus indologenus, Aspergillus inflatus, Aspergillus ingratus, Aspergillus insecticola, Aspergillus insolitus, Aspergillus insuetus, Aspergillus insulicola, Aspergillus intermedius, Aspergillus inuii, Aspergillus itaconicus, Aspergillus ivoriensis, Aspergillus jaipurensis, Aspergillus janus, Aspergillus japonicus, Aspergillus jeanselmei, Aspergillus jensenii, Aspergillus kambarensis, Aspergillus kanagawaensis, Aspergillus kassunensis, Aspergillus katsuobushi, Aspergillus keveii, Aspergillus koningii, Aspergillus laciniosus, Aspergillus lacticoffeatus, Aspergillus laneus, Aspergillus lanosus, Aspergillus laokiashanensis, Aspergillus lateralis, Aspergillus lentulus, Aspergillus lepidophyton, Aspergillus leporis, Aspergillus leucocarpus, Aspergillus levisporus, Aspergillus lignieresii, Aspergillus longivesica, Aspergillus longobasidia, Aspergillus luchensi, Aspergillus luchuensis, Aspergillus lucknowensis, Aspergillus luppii, Aspergillus luteoniger, Aspergillus luteovirescens, Aspergillus lutescens, Aspergillus luteus, Aspergillus macfiei, Aspergillus macrosporus, Aspergillus magnivesiculatus, Aspergillus malignus, Aspergillus malodoratus, Aspergillus malvaceus, Aspergillus mandshuricus, Aspergillus mangaliensis, Aspergillus manginii, Aspergillus mannitosus, Aspergillus maritimus, Aspergillus marvanovae, Aspergillus mattletii, Aspergillus maximus, Aspergillus medius, Aspergillus melitensis, Aspergillus melleus, Aspergillus mellinus, Aspergillus mencieri, Aspergillus michelii, Aspergillus microcephalus, Aspergillus microcysticus, Aspergillus micronesiensis, Aspergillus microsporus, Aspergillus microthecius, Aspergillus microviridicitrinus, Aspergillus minimus, Aspergillus minisclerotigenes, Aspergillus minor, Aspergillus minutus, Aspergillus miyajii, Aspergillus miyakoensis, Aspergillus mollis, Aspergillus monodii, Aspergillus montenegroi, Aspergillus montevidensis, Aspergillus mottae, Aspergillus mucoroides, Aspergillus mucoroideus, Aspergillus muelleri, Aspergillus multicolor, Aspergillus multiplicatus, Aspergillus muricatus, Aspergillus muscivora, Aspergillus mutabilis, Aspergillus mycetomi-villabruzzii, Aspergillus mycobanche, Aspergillus nakazawae, Aspergillus nantae, Aspergillus nanus, Aspergillus navahoensis, Aspergillus neoafricanus, Aspergillus neoauricomus, Aspergillus neobridgeri, Aspergillus neocarnoyi, Aspergillus neoechinulatus, Aspergillus neoellipticus, Aspergillus neoglaber, Aspergillus neoindicus, Aspergillus neoniger, Aspergillus neoniveus, Aspergillus nidulans, Aspergillus nidulellus, Aspergillus niger, Aspergillus nigrescens, Aspergillus nigricans, Aspergillus nishimurae, Aspergillus niveoglaucus, Aspergillus niveus, Aspergillus noelting, Aspergillus nominus, Aspergillus nomius, Aspergillus novoparasiticus, Aspergillus novofumigatus, Aspergillus novus, Aspergillus occultus, Aspergillus ochraceopetaliformis, Aspergillus ochraceoroseus, Aspergillus ochraceoruber, Aspergillus ochraceus, Aspergillus oerlinghausenensis, Aspergillus okazakii, Aspergillus olivaceofuscus, Aspergillus olivaceus, Aspergillus olivascens, Aspergillus olivicola, Aspergillus omanensis, Aspergillus onikii, Aspergillus oosporus, Aspergillus ornatulus, Aspergillus ornatus, Aspergillus oryzae, Aspergillus osmophilus, Aspergillus ostianus, Aspergillus otanii, Aspergillus ovalispermus, Aspergillus pachycaulis, Aspergillus pachycristatus, Aspergillus paleaceus, Aspergillus pallidofulvus, Aspergillus pallidus, Aspergillus panamensis, Aspergillus papuensis, Aspergillus paradoxus, Aspergillus parafelis, Aspergillus parasiticus, Aspergillus parrulus, Aspergillus parvathecius, Aspergillus parvisclerotigenus, Aspergillus parviverruculosus, Aspergillus parvulus, Aspergillus paulistensi, Aspergillus penicillatus, Aspergillus penicilliformis, Aspergillus penicillioides, Aspergillus penicillioideum, Aspergillus penicillopsis, Aspergillus periconioides, Aspergillus pernambucoensis, Aspergillus perniciosus, Aspergillus persii, Aspergillus petersonii, Aspergillus petrakii, Aspergillus peyronelii, Aspergillus phaeocephalus, Aspergillus phialiseptatus, Aspergillus phoenicis, Aspergillus pidoplichknovii, Aspergillus piperis, Aspergillus pisci, Aspergillus pluriseminatus, Aspergillus polychromus, Aspergillus polyporicola, Aspergillus porphyreostipitatus, Aspergillus pouchetii, Aspergillus primulinus, Aspergillus profusus, Aspergillus proliferans, Aspergillus protuberus, Aspergillus posadasensis, Aspergillus pragensis, Aspergillus pseudocaelatus, Aspergillus pseudocarbonarius, Aspergillus pseudocitricus, Aspergillus pseudoclavatus, Aspergillus pseudodeflectus, Aspergillus pseudoelatior, Aspergillus pseudoelegans, Aspergillus pseudoflavus, Aspergillus pseudoglaucus, Aspergillus pseudoheteromorphus, Aspergillus pseudoniger, Aspergillus pseudonomius, Aspergillus pseudotamarii, Aspergillus pseudoviridinutans, Aspergillus pulchellus, Aspergillus pulmonum-hominis, Aspergillus pulverulentus, Aspergillus pulvericola, Aspergillus pulvinus, Aspergillus puniceus, Aspergillus purpureofuscus, Aspergillus purpureus, Aspergillus pusillus, Aspergillus puulaauensis, Aspergillus pyramidus, Aspergillus pyri, Aspergillus qinqixianii, Aspergillus qizutongii, Aspergillus quadricinctus, Aspergillus quadricingens, Aspergillus quadrifidus, Aspergillus quadrilineatus, Aspergillus quercinus, Aspergillus quininae, Aspergillus quitensis, Aspergillus racemosus, Aspergillus raianus, Aspergillus rambellii, Aspergillus ramosus, Aspergillus raperi, Aspergillus recurvatus, Aspergillus rehmii, Aspergillus repandus, Aspergillus repens, Aspergillus reptans, Aspergillus restrictus, Aspergillus reticulatus, Aspergillus rhizopodus, Aspergillus robustus, Aspergillus roseoglobosus, Aspergillus roseoglobulosus, Aspergillus roseovelutinus, Aspergillus roseus, Aspergillus ruber, Aspergillus rubrobrunneus, Aspergillus rubrum, Aspergillus rufescens, Aspergillus rugulosus, Aspergillus rugulovalvus, Aspergillus rutilans, Aspergillus sacchari, Aspergillus saccharolyticus, Aspergillus saitoi, Aspergillus salwaensis, Aspergillus sclerotialis, Aspergillus salviicola, Aspergillus sartoryi, Aspergillus savannensis, Aspergillus scheelei, Aspergillus schiemanniae, Aspergillus sclerogenus, Aspergillus sclerotiicarbonarius, Aspergillus sclerotioniger, Aspergillus sclerotiorum, Aspergillus sejunctus, Aspergillus septatus, Aspergillus sepultus, Aspergillus sergii, Aspergillus sesamicola, Aspergillus shendaweii, Aspergillus siamensis, Aspergillus silvaticus, Aspergillus similis, Aspergillus simplex, Aspergillus sloanii, Aspergillus solicola, Aspergillus sojae, Aspergillus sparsus, Aspergillus spathulatus, Aspergillus spectabilis, Aspergillus spelaeus, Aspergillus spelunceus, Aspergillus spiculosus, Aspergillus spinosus, Aspergillus spinulosus, Aspergillus spiralis, Aspergillus stella-maris, Aspergillus stellatus, Aspergillus stellifer, Aspergillus stercorarius, Aspergillus sterigmatophorus, Aspergillus steynii, Aspergillus stramenius, Aspergillus striatulus, Aspergillus striatus, Aspergillus stromatoides, Aspergillus strychni, Aspergillus subalbidus, Aspergillus subfuscus, Aspergillus subgriseus, Aspergillus sublatus, Aspergillus sublevisporus, Aspergillus subolivaceus, Aspergillus subramanianii, Aspergillus subsessilis, Aspergillus subunguis, Aspergillus subversicolor, Aspergillus sulphureoviridis, Aspergillus sulphureus, Aspergillus sunderbanii, Aspergillus sydowii, Aspergillus sylvaticus, Aspergillus syncephalis, Aspergillus tabacinus, Aspergillus taichungensis, Aspergillus takakii, Aspergillus taklimakanensis, Aspergillus tamari, Aspergillus tanneri, Aspergillus tapirirae, Aspergillus tardus, Aspergillus tatenoi, Aspergillus templicola, Aspergillus tennesseensis, Aspergillus terrestris, Aspergillus terreus, Aspergillus terricola, Aspergillus testaceocolorans, Aspergillus tetrazonus, Aspergillus thermomutatus, Aspergillus thomi, Aspergillus tiraboschii, Aspergillus togoensis, Aspergillus tokelau, Aspergillus tonophilus, Aspergillus toxicarius, Aspergillus transcarpathicus, Aspergillus trinidadensis, Aspergillus tritici, Aspergillus tsurutae, Aspergillus tuberculatus, Aspergillus tubingensis, Aspergillus tunetanus, Aspergillus turcosus, Aspergillus udagawae, Aspergillus umbrinus, Aspergillus umbrosus, Aspergillus undulatus, Aspergillus unguis, Aspergillus unilateralis, Aspergillus usamii, Aspergillus ustilago, Aspergillus ustus, Aspergillus uvarum, Aspergillus vadensis, Aspergillus vancampenhoutii, Aspergillus varanasensis, Aspergillus variabilis, Aspergillus varians, Aspergillus variecolor, Aspergillus variegatus, Aspergillus velutinus, Aspergillus venenatus, Aspergillus venezuelensis, Aspergillus versicolor, Aspergillus vinosobubalinus, Aspergillus violaceobrunneus, Aspergillus violaceofuscus, Aspergillus violaceus, Aspergillus virens, Aspergillus viridigriseus, Aspergillus viridinutans, Aspergillus vitellinus, Aspergillus vitis, Aspergillus vitricola, Aspergillus waksmanii, Aspergillus wangduanlii, Aspergillus warcupii, Aspergillus wehmeri, Aspergillus welwitschiae, Aspergillus wentii, Aspergillus westendorpii, Aspergillus westlandensis, Aspergillus westerdijkiae, Aspergillus wyomingensis, Aspergillus xerophilus, Aspergillus yezoensis, Aspergillus zhaoqingensis, Aspergillus zonatus, or any combination thereof. In some aspects, the Aspergillus sp. product comprises Aspergillus niger.

In some aspects, the Aspergillus sp. product is a fermented mold comprising one or more Aspergillus sp. A fermented mold comprising one or more Aspergillus sp. can support digestion stemming from the fermentation process. This process results in trillions of beneficial bacteria and their metabolites being produced in the product. Additionally, the product from the fermentation process is predigested, which means less work for pets when digesting it themselves. The fermentation process also produces key nutrients, such as B vitamins, niacin, biotin, folic acid and over a dozen highly digestible amino acids, which all collectively work to support an animal's gut health and immune systems.

In some aspects, the Aspergillus sp. product is a koji mold fermented product comprising an Aspergillus sp. A koji mold is a type of edible mold culture made up of mostly Aspergillus oryzae and is used in many food applications to ferment soy sauce, miso, sake, and other common Japanese fermented foods. The koji releases a suite of protease and amylase enzymes into the raw material mixture. The proteases cause the soy and wheat proteins to hydrolyze into amino acids and small peptides. The amylases convert starches in the wheat into simple sugars, which provide energy for the koji to live and imparts sweetness to the soy sauce. In some aspects, the Aspergillus sp. product is a koji mold comprising Aspergillus niger. In some aspects, the Aspergillus sp. product is a dried Aspergillus niger product of solid state fermentation (SSF), which is a protein source having nutrient specifications that are similar to meats like beef and lamb while being made through a natural fermentation process, allowing for a consistent delivery of nutrients along with functional properties that aren't available in traditional meat options.

The animal food composition can comprise about 5% or less, about 4% or less, about 3% or less, about 2% or less, about 1% or less, about 0.5% or less Aspergillus sp. product. In some aspects, the animal food composition comprises about 2% or less Aspergillus sp. product. In some aspects, the animal food comprises 25% or more yeast product.

### (c) Essential Nutrients

To generate a nutritionally complete animal food product, an animal food product of the instant disclosure further comprises various plant, fruit and plant-and fruit-based ingredients (for example kale, squash, peanuts, banana, nuts, seeds, and others-see Examples below), and additional essential nutrients complementing the nutritional value of the yeast product and Aspergillus sp. product. Elements essential for an animal's nutrition are known in the art and include vitamins minerals, and carbohydrates, to name a few. In some aspects, the essential nutrients comprise a blend of essential minerals and vitamins for animals. In some aspects, the essential nutrients comprise a blend of essential minerals and vitamins for animals, and choline.

### (d) Other Ingredients

The animal food compositions of the instant disclosure can further comprise additional ingredients that can improve the palatability and other characteristics of the animal food. For instance, the animal food can further comprise sweeteners, textural agents, flavoring agents, preservatives, gelling agents, salt, emulsifiers or surfactants, colorants, and antioxidants. In some aspects, the animal food compositions of the instant disclosure further comprise oats, sweet potato, chia seed, pumpkin seed, sunflower seed, apples, bananas, coconut flour, salt, camelina oil, and Omega-3 fatty acids such as docosahexaenoic acid (DHA).

### II. Methods

Another aspect of the instant disclosure encompasses a method of preparing a nutritionally complete solid freeze-dried animal food composition. The method comprises the steps of (a) combining the ingredients of the animal food to form a paste comprising a yeast product, an Aspergillus sp. product and essential nutrients by hydrating the dry yeast product and the dry Aspergillus sp. product with a fluid; (b) shaping the paste to form a shaped paste; and (c) freeze-drying the shaped paste. The dry yeast product and the dry Aspergillus sp. product can be combined with the fluid in a volume ratio of about 1 part fluid to about 5 parts powder dry yeast product and powder dry Aspergillus sp. product or any other ratio of fluid to powder that can produce a paste comprising a consistency suitable for shaping and further processing. Depending on the level of hydration of ingredients other than the yeast product and Aspergillus sp. product, the fluid can be added to the mixture of ingredients to achieve a paste or can be a component of one or more of the other ingredients. For instance, if the ingredients comprise bananas and sweet potatoes, the level of hydration of the potatoes and bananas may be sufficient to produce a paste of desired consistency without addition of fluid. In some aspects, the totality of ingredients do not provide sufficient hydration, and a fluid is added to the ingredients. In some aspects, the fluid is water.

The shaped paste can be in a form suitable for further processing. For instance, the paste can be shaped into a form suitable for consumption by the animal, or into a shape suitable for freezing to further shape the paste. When the paste is shaped into a shape suitable for freezing to further shape the paste, the paste can be shaped into a sheet and cut into strips for freezing before dicing the strips of frozen shaped paste into a form suitable for consumption by the animal. A form suitable for consumption by the animal can be as described herein above.

In some aspects, the method of the instant disclosure further comprises freezing the shaped paste to form a frozen paste. In general, the paste is shaped into a form suitable for consumption by the animal before freeze drying. In some aspects, the paste is frozen before shaping the paste shaped into a form suitable for consumption by the animal before freeze drying. Alternatively, the paste can be shaped into a form suitable for consumption by the animal before freezing. The shaped paste can be frozen to a temperature ranging from about −30° F. to about 10° F., from about −25° F. to about 5° F., from about −20° F. to about 0° F., from about −15° F. to about −5° F., or from about −12° F. to about −8° F. In some aspects, the shaped paste is frozen to a temperature of about −10° F.

When the paste is frozen, the method can also further comprise tempering the paste before or after freeze-drying. The paste can be tempered to a temperature ranging from about 0° F. to about 30° F., from about 5° F. to about 25° F., from about 10° F. to about 20° F., or from about 12° F. to about 17° F. In some aspects, the paste is tempered to a temperature of about 15° F.

Yet another aspect of the instant disclosure encompasses a method of feeding an animal a nutritionally complete meat-free food product. The method comprises feeding the animal a solid freeze-dried animal food, wherein the nutritionally complete food maintains or improves gut health and immunity, or any combination thereof.

### DEFINITIONS

The use of the word “a,” “an,” “the” or “said,” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of.” As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about,” “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as still having the required characteristics and capabilities of the unmodified feature. In general, but subject to the preceding discussion, a numerical value herein that is modified by a word of approximation such as “about” may vary from the stated value by at least +1, 2, 3, 4, 5, 6, 7, 10, 12 or 15%.

All patents and publications mentioned in the specification are indicative of the levels of those skilled in the art to which the present disclosure pertains. All patents and publications are herein incorporated by reference to the same extent as if cach individual publication was specifically and individually indicated to be incorporated by reference.

The publications discussed throughout are provided solely for their disclosure before the filing date of the present application. Nothing herein is to be construed as an admission that the invention is not entitled to antedate such disclosure by virtue of prior invention.

### EXAMPLES

The following examples are included to demonstrate illustrative embodiments of the present disclosure. It should be appreciated by those of skill in the art that the techniques disclosed in the examples that follow represent techniques discovered by the inventor to function well in the practice of the present disclosure, and thus can be considered to constitute one embodiment of modes for its practice. However, those of skill in the art should, in light of the present disclosure, appreciate that many changes can be made in the specific embodiments that are disclosed and still obtain a like or similar result without departing from the spirit and scope of the present disclosure. As various changes could be made in the above-described compositions and methods without departing from the scope of the present disclosure, it is intended that all matter contained in the above description and in the examples given below, shall be interpreted as illustrative and not in a limiting sense.

### Example 1. Method of Preparing a Freeze Fried Yeast Food Product

To arrive at a meat-free freeze-dried food product for animals such as cats and dogs, dried, inactive yeast and dried Aspergillus Niger fermentation product were blended together in powdered, dry form to form a yeast blend. Water was then added to the yeast blend and the yeast blend was frozen at the temperature of 12-14° F. to create a dense, thick, wet textured paste. This paste was then diced into various shapes and sizes using a custom dicing machine, depending on the final desired size of product, while still at a frozen temperature to maintain texture. The diced product was placed in a freeze dryer for 12-20 hours to have moisture removed which allowed it to maintain shelf stability and brittleness. Importantly, to date, there is no current freeze-dried treatment of a powdered product on the pet market.

Some steps in the method include:
1. The dry yeast was weighed into batches and placed into a bowl mixer for mixing while fluid was slowly added to ensure uniform consistency and mixing. This step was about 1 part fluid to 5 parts powder.
2. Once the last amount of fluid was added, mixing continued until the powder was fully blended and a yeast paste was formed.
3. The yeast paste was then removed from the bowl and run through a forming machine. The paste was then placed into holding containers for deep freezing.
4. Once the yeast product reached a temperature of −10° F., it was moved to a tempering freezer. The tempering freezer was set at 15° F. and it took 2-3 days to slowly increase the temperature of the yeast product to 15° F.
5. When the yeast product reached a temperature of 15° F., it was removed from the tempering freezer and run through a CMD 3D Dicer for dicing. Depending on specifications, the product could be diced at ¼″ up to ½″.
6. Once the product was diced into the desired size, it was quickly trayed and moved into a freezer to avoid “melting” out of form.
7. After the diced product was frozen it was loaded into a freeze dryer where a gentle drying approach was applied to ensure the final integrity of the product.

### Example 2. Composition and Nutritional Analysis of an Animal Breakfast Food

The ingredients of an animal breakfast food is shown below in Table 1, and the nutritional value of an animal breakfast food is shown in Table 2.

TABLE 1

| Ingredient | % As Fed |
|---|---|
| Yeast Blend | 35.000 |
| 20038 Oats | 15.000 |
| 11508 Sweet Potato, ckd, b | 12.000 |
| 12014 Pumpkin & Squash | 9.965 |
| 12006 Chia Seeds, Dried | 8.000 |
| Sunflower Seeds, Whole | 4.500 |
| 09003 Apples, Raw, With Sk | 3.000 |
| 09040 Bananas, Raw | 3.000 |
| Premix Blend | 1.120 |
| Salt, Table | 0.310 |
| Camelina Oil | 0.300 |
| Algae Powder - 30% DHA | 0.296 |
| Choline Chloride - ADM | 7.600 |
| Vita-D Yeast | 0.010 |
| Peanut Powder - ADM | 2.900 |
| Total | 100.00 |

TABLE 2

| Nutrient | As Fed | | Dry M | |
|---|---|---|---|---|
| Energy | 1862.146 | kcal/kg | 2269.155 | kcal/kg |
| Protein | 23.000% | | 28.027% | |
| Arginine | 0.841% | | 1.025% | |
| Histidine | 0.193% | | 0.235% | |
| Isoleucine | 0.318% | | 0.388% | |
| Leucine | 0.562% | | 0.685% | |
| Lysine | 0.323% | | 0.394% | |
| Methionine | 0.163% | | 0.198% | |
| Methionine + Cystine | 0.304% | | 0.370% | |
| Phenylalanine | 0.404% | | 0.493% | |
| Phelylalanine + Tyrosine | 0.647% | | 0.788% | |
| Threonine | 0.268% | | 0.327% | |
| Tryptophan | 0.131% | | 0.159% | |
| Valine | 0.401% | | 0.488% | |
| Total Lipid (Fat) | 11.039% | | 13.452% | |
| Linoleic acid | 3.375% | | 4.112% | |
| Alpha-linolenic acid | 1.570% | | 1.913% | |
| Arachidonic acid | 0.009% | | 0.011% | |
| 22:6 n-3 (DHA) | 0.089% | | 0.108% | |
| 20:5 n-3 (EPA) | 0.001% | | 0.001% | |
| EPA + DHA | 0.090% | | 0.110% | |
| Omega 6 FA | 3.384% | | 4.123% | |
| Omega 3 FA | 1.660% | | 2.023% | |
| Omega 3 Fas | 1.574% | | 1.917% | |
| Calcium | 1.072% | | 1.306% | |
| Phosphorus | 0.780% | | 0.950% | |
| Potassium | 0.828% | | 1.009% | |
| Magnesium | 0.200% | | 0.244% | |
| Sodium | 0.134% | | 0.164% | |
| Chloride | 0.120% | | 0.146% | |
| Iron | 81.717 | mg/kg | 99.578 | mg/kg |
| Copper | 19.125 | mg/kg | 23.305 | mg/kg |
| Manganese | 26.671 | mg/kg | 32.501 | mg/kg |
| Zinc | 124.834 | mg/kg | 152.119 | mg/kg |
| Iodine | 1.603 | mg/kg | 1.953 | mg/kg |
| Selenium | 355.100 | mcg/kg | 432.714 | mcg/kg |
| Vitamin A, IU | 37361.892 | IU/kg | 45528.078 | IU/kg |
| Vitamin D | 800.000 | IU/kg | 974.856 | IU/kg |
| Vitamin E (alpha-tocopherol) | 61.435 | mg/kg | 74.863 | mg/kg |
| Thiamin | 8.939 | mg/kg | 10.893 | mg/kg |
| Riboflavin | 7.096 | mg/kg | 8.647 | mg/kg |
| Pantothenic acid | 18.906 | mg/kg | 23.038 | mg/kg |
| Niacin | 44.873 | mg/kg | 54.681 | mg/kg |
| Vitamin B-6 | 3.617 | mg/kg | 4.408 | mg/kg |
| Folic acid | 448.000 | mcg/kg | 545.919 | mcg/kg |
| Vitamin B-12 | 28.000 | mcg/kg | 34.120 | mcg/kg |
| Choline, total | 34134.788 | mg/kg | 41595.626 | mg/kg |
| Taurine | 0.000% | | 0.000% | |
| Carnitine | 0.000 | mg/kg | 0.000 | mg/kg |
| Carbohydrate, by differen | 33.747% | | 41.123% | |
| Fiber, total dietary | 7.275% | | 8.865% | |
| Water | 16.182% | | 19.719% | |
| Ash | 3.919% | | 4.776% | |
| Energy KJ | 7.429 | MJ/kg | 9.053 | MJ/kg |
| Vitamin D (D2 + D3 | 0.000 | mcg/kg | 0.000 | mcg/kg |
| Cystine | 0.141% | | 0.172% | |
| Tyrosine | 0.243% | | 0.296% | |
| Vitamin D2 (ergocalcifero | 0.000 | mcg/kg | 0.000 | mcg/kg |
| Vitamin A, RAE | 1157.046 | mcg/kg | 1409.942 | mcg/kg |
| Carotene, beta | 13846.468 | mcg/kg | 16872.890 | mcg/kg |
| Vitamin D3 (cholecalcifer | 0.000 | mcg/kg | 0.000 | mcg/kg |
| Lycopene | 0.000 | mcg/kg | 0.000 | mcg/kg |
| Retinol | 0.000 | mcg/kg | 0.000 | mcg/kg |
| Lutein + zeaxanthin | 66.841 | mcg/kg | 81.450 | mcg/kg |
| Tocopherol, beta | 0.552 | mg/kg | 0.673 | mg/kg |
| Tocopherol, gamma | 24.631 | mg/kg | 30.015 | mg/kg |
| Tocopherol, delta | 0.318 | mg/kg | 0.388 | mg/kg |
| Tocotrienol, alpha | 0.042 | mg/kg | 0.051 | mg/kg |
| Tocotrienol, beta | 0.000 | mg/kg | 0.000 | mg/kg |
| Tocotrienol, gamma | 0.042 | mg/kg | 0.051 | mg/kg |
| Tocotrienol, delta | 0.000 | mg/kg | 0.000 | mg/kg |
| Vitamin C, total ascorbic | 30.743 | mg/kg | 37.463 | mg/kg |
| Folate, total | 279.847 | mcg/kg | 341.013 | mcg/kg |
| Menaquinone-4 | 0.000 | mcg/kg | 0.000 | mcg/kg |
| Dihydrophylloquinone | 0.000 | mcg/kg | 0.000 | mcg/kg |
| Vitamin K (phylloquinone) | 8.654 | mcg/kg | 10.546 | mcg/kg |
| Folate, food | 279.847 | mcg/kg | 341.013 | mcg/kg |
| Folate, DFE | 240.647 | mcg/kg | 293.245 | mcg/kg |
| Betaine | 57.510 | mg/kg | 70.080 | mg/kg |
| Alanine | 0.383% | | 0.466% | |
| Aspartic acid | 0.733% | | 0.893% | |
| Glutamic acid | 1.548% | | 1.886% | |
| Glycine | 0.407% | | 0.496% | |
| Proline | 0.356% | | 0.434% | |
| Serine | 0.376% | | 0.459% | |
| Hydroxyproline | 0.000% | | 0.000% | |
| Vitamin E, added | 0.000 | mg/kg | 0.000 | mg/kg |
| Vitamin B-12, added | 0.000 | mcg/kg | 0.000 | mcg/kg |
| Cholesterol | 0.000 | mg/kg | 0.000 | mg/kg |
| Fatty acids, total trans | 0.016% | | 0.019% | |
| Fatty acids, total saturate | 1.263% | | 1.539% | |
| 4:0 | 0.000% | | 0.000% | |
| 6:0 | 0.000% | | 0.000% | |
| 8:0 | 0.000% | | 0.000% | |
| 10:0 | 0.000% | | 0.000% | |
| 12:0 | 0.004% | | 0.005% | |
| 14:0 | 0.010% | | 0.012% | |
| 16:0 | 0.812% | | 0.989% | |
| 18:0 | 0.359% | | 0.438% | |
| 20:0 | 0.027% | | 0.033% | |
| 18:1 undifferentiated | 2.453% | | 2.989% | |
| 22:0 | 0.021% | | 0.026% | |
| 14:1 | 0.002% | | 0.003% | |
| 16:1 undifferentiated | 0.009% | | 0.011% | |
| 18:4 | 0.001% | | 0.001% | |
| 20:1 | 0.011% | | 0.014% | |
| 22:1 undifferentiated | 0.001% | | 0.002% | |
| 22:5 n-3 (DPA) | 0.000% | | 0.000% | |
| Phytosterols | 248.700 | mg/kg | 303.058 | mg/kg |
| Stigmasterol | 0.000 | mg/kg | 0.000 | mg/kg |
| Campesterol | 0.000 | mg/kg | 0.000 | mg/kg |
| Beta-sitosterol | 0.000 | mg/kg | 0.000 | mg/kg |
| Fatty acids, total monoun | 2.478% | | 3.019% | |
| Fatty acids, total polyuns | 4.790% | | 5.837% | |
| 15:0 | 0.003% | | 0.004% | |
| 17:0 | 0.009% | | 0.010% | |
| 24:0 | 0.006% | | 0.008% | |
| 16:1 t | 0.000% | | 0.000% | |
| 18:1 t | 0.002% | | 0.002% | |
| 22:1 t | 0.000% | | 0.000% | |
| 18:2 t not further defined | 0.003% | | 0.003% | |
| 18:2 i | 0.000% | | 0.000% | |
| 18:2 t, t | 0.000% | | 0.000% | |
| 18:2 CLAs | 0.000% | | 0.000% | |
| 24:1 c | 0.000% | | 0.000% | |
| 20:2 n-6 c, c | 0.000% | | 0.000% | |
| 16:1 c | 0.003% | | 0.004% | |
| 18:1 c | 1.122% | | 1.367% | |
| 18:2 n-6 c, c | 1.906% | | 2.323% | |
| 22:1 c | 0.000% | | 0.000% | |
| 18:3 n-6 c, c, c | 0.000% | | 0.000% | |
| 17:1 | 0.001% | | 0.001% | |
| 20:3 undifferentiated | 0.000% | | 0.000% | |
| Fatty acids, total trans-m | 0.002% | | 0.002% | |
| Fatty acids, total trans-po | 0.003% | | 0.003% | |
| Omega-6 Fas | 3.387% | | 4.127% | |
| 13:0 | 0.000% | | 0.000% | |
| 15:1 | 0.000% | | 0.000% | |
| 18:3 n-3 c, c, c (ALA) | 1.435% | | 1.748% | |
| 20:3 n-3 | 0.000% | | 0.000% | |
| 20:3 n-6 | 0.000% | | 0.000% | |
| 20:4 n-6 | 0.000% | | 0.000% | |
| 18:3i | 0.000% | | 0.000% | |
| 21:5 | 0.000% | | 0.000% | |
| 22:4 | 0.000% | | 0.001% | |
| 18:1-11 t (18:1t n-7) | 0.000% | | 0.000% | |
| Starch | 1.111% | | 1.354% | |
| Sucrose | 0.599% | | 0.729% | |
| Glucose (dextrose) | 0.300% | | 0.365% | |
| Fructose | 0.393% | | 0.479% | |
| Lactose | 0.000% | | 0.000% | |
| Maltose | 0.375% | | 0.457% | |
| Alcohol, ethyl | 0.000% | | 0.000% | |
| Adjusted Protein | 0.000% | | 0.000% | |
| Caffeine | 0.000 | mg/kg | 0.000 | mg/kg |
| Theobromine | 0.000 | mg/kg | 0.000 | mg/kg |
| Sugars, total | 1.672% | | 2.037% | |
| Galactose | 0.000% | | 0.000% | |
| Fluoride | 1.712 | mcg/kg | 2.086 | mcg/kg |
| Carotene, alpha | 59.796 | mcg/kg | 72.866 | mcg/kg |
| Cryptoxanthin, beta | 3.996 | mcg/kg | 4.870 | mcg/kg |

The yeast blend is 90-95% dried. nutritional yeast (Saccharomyces cerevisiae) and 5-10% koji (dried Aspergillus niger fermentation product), and the nutritional value of the yeast blend is shown in Table 3.

TABLE 3
Typical Nutritional Profile (As Is Basis)

| Energy | |
|---|---|
| Crude Fat, % | 0.4 |
| NFE, % | 22.92 |
| Acid Detergent Fiber, % | 18 |
| Protein, Amino Acids | |
| Crude Protein, % | 44 |
| Amino Acids, % | |
| Lysine | 2.43 |
| Alanine | 2.54 |
| Arginine | 2.33 |
| Aspartic Acid | 3.75 |
| Cystine | 0.51 |
| Glutamic Acid | 5.56 |
| Glycine | 1.88 |
| Histidine | 0.96 |
| Isoleucine | 1.61 |
| Leucine | 2.90 |
| Methionine | 0.55 |
| Phenylalanine | 1.72 |
| Proline | 2.01 |
| Serine | 2.26 |
| Threonine | 1.92 |
| Tyrosine | 1.44 |
| Valine | 2.11 |
| Tryptophan | 0.54 |
| Major Minerals | |
| Total Ash, % | 7.78 |
| Sulfur, % | 0.40 |
| Sodium, % | 0.02 |
| Phosphorus, % | 1.29 |
| Potassium, % | 1.60 |
| Magnesium, % | 0.23 |
| Calcium, % | 0.37 |
| Trace Minerals, ppm | |
| Iron | 77.4 |
| Copper | 16.9 |
| Zinc | 94.5 |
| Manganese | 21.2 |

The nutritional value of the premix blend is shown in Table 4.

TABLE 4

| Nutrient | As Fed | | Dry M | |
|---|---|---|---|---|
| Energy | 0.0000 | kcal/kg | 0.0000 | kcal/kg |
| Protein | 0.0000% | | 0.0000% | |
| Arginine | 0.0000% | | 0.0000% | |
| Histidine | 0.0000% | | 0.0000% | |
| Isoleucine | 0.0000% | | 0.0000% | |
| Leucine | 0.0000% | | 0.0000% | |
| Lysine | 0.0000% | | 0.0000% | |
| Methionine | 0.0000% | | 0.0000% | |
| Methionine + Cystine | 0.0000% | | 0.0000% | |
| Phenylalanine | 0.0000% | | 0.0000% | |
| Phelylalanine + Tyrosine | 0.0000% | | 0.0000% | |
| Threonine | 0.0000% | | 0.0000% | |
| Tryptophan | 0.0000% | | 0.0000% | |
| Valine | 0.0000% | | 0.0000% | |
| Total Lipid (Fat) | 0.0000% | | 0.0000% | |
| Linoleic acid | 0.0000% | | 0.0000% | |
| Alpha-linolenic acid | 0.0000% | | 0.0000% | |
| Arachidonic acid | 0.0000% | | 0.0000% | |
| 22:6 n-3 (DHA) | 0.0000% | | 0.0000% | |
| 20:5 n-3 (EPA) | 0.0000% | | 0.0000% | |
| EPA + DHA | 0.0000% | | 0.0000% | |
| Omega 6 FA | 0.0000% | | 0.0000% | |
| Omega 3 FA | 0.0000% | | 0.0000% | |
| Omega 3 Fas | 0.0000% | | 0.0000% | |
| Calcium | 82.2500% | | 82.2500% | |
| Phosphorus | 5.7750% | | 5.7750% | |
| Potassium | 0.0000% | | 0.0000% | |
| Magnesium | 0.0000% | | 0.0000% | |
| Sodium | 0.0000% | | 0.0000% | |
| Chloride | 0.0000% | | 0.0000% | |
| Iron | 3217.5000 | mg/kg | 3217.5000 | mg/kg |
| Copper | 907.5000 | mg/kg | 907.5000 | mg/kg |
| Manganese | 470.0000 | mg/kg | 470.0000 | mg/kg |
| Zinc | 7260.0000 | mg/kg | 7260.0000 | mg/kg |
| Iodine | 130.0000 | mg/kg | 130.0000 | mg/kg |
| Selenium | 25000.0000 | mcg/kg | 25000.0000 | mcg/kg |
| Vitamin A, IU | 1266790.0000 | IU/kg | 1266790.0000 | IU/kg |
| Vitamin D | 0.0000 | IU/kg | 0.0000 | IU/kg |
| Vitamin E (alpha-tocopherol) | 3817.3250 | mg/kg | 3817.3250 | mg/kg |
| Thiamin | 562.5000 | mg/kg | 562.5000 | mg/kg |
| Riboflavin | 565.0000 | mg/kg | 565.0000 | mg/kg |
| Pantothenic acid | 1310.0000 | mg/kg | 1310.0000 | mg/kg |
| Niacin | 2422.5000 | mg/kg | 2422.5000 | mg/kg |
| Vitamin B-6 | 202.5000 | mg/kg | 202.5000 | mg/kg |
| Folic acid | 40000.0000 | mcg/kg | 40000.0000 | mcg/kg |
| Vitamin B-12 | 2500.0000 | mcg/kg | 2500.0000 | mcg/kg |
| Biotin | 0.0000 | mg/kg | 0.0000 | mg/kg |
| Choline, total | 0.0000 | mg/kg | 0.0000 | mg/kg |
| Taurine | 0.000% | | 0.000% | |
| Carnitine | 0.000 | mg/kg | 0.000 | mg/kg |
| Carbohydrate, by differen | 0.0000% | | 0.0000% | |
| Fiber, total dietary | 0.0000% | | 0.0000% | |
| Water | 0.0000% | | 0.0000% | |
| Ash | 0.0000% | | 0.0000% | |
| Energy KJ | 0.0000 | MJ/kg | 0.0000 | MJ/kg |
| Vitamin D (D2 + D3 | 0.0000 | mcg/kg | 0.0000 | mcg/kg |
| Cystine | 0.0000% | | 0.0000% | |
| Tyrosine | 0.0000% | | 0.0000% | |
| Vitamin D2 (ergocalcifero | 0.0000 | mcg/kg | 0.0000 | mcg/kg |
| Vitamin A, RAE | 0.0000 | mcg/kg | 0.0000 | mcg/kg |
| Carotene, beta | 0.0000 | mcg/kg | 0.0000 | mcg/kg |
| Vitamin D3 (cholecalcifer | 0.000 | mcg/kg | 0.000 | mcg/kg |
| Lycopene | 0.000 | mcg/kg | 0.000 | mcg/kg |
| Retinol | 0.000 | mcg/kg | 0.000 | mcg/kg |
| Lutein + zeaxanthin | 0.0000 | mcg/kg | 0.0000 | mcg/kg |
| Tocopherol, beta | 0.0000 | mg/kg | 0.0000 | mg/kg |
| Tocopherol, gamma | 0.0000 | mg/kg | 0.0000 | mg/kg |
| Tocopherol, delta | 0.0000 | mg/kg | 0.0000 | mg/kg |
| Tocotrienol, alpha | 0.0000 | mg/kg | 0.0000 | mg/kg |
| Tocotrienol, beta | 0.0000 | mg/kg | 0.0000 | mg/kg |
| Tocotrienol, gamma | 0.0000 | mg/kg | 0.0000 | mg/kg |
| Tocotrienol, delta | 0.0000 | mg/kg | 0.0000 | mg/kg |
| Vitamin C, total ascorbic | 0.0000 | mg/kg | 0.0000 | mg/kg |
| Folate, total | 0.0000 | mcg/kg | 0.0000 | mcg/kg |
| Menaquinone-4 | 0.0000 | mcg/kg | 0.0000 | mcg/kg |
| Dihydrophylloquinone | 0.0000 | mcg/kg | 0.0000 | mcg/kg |
| Vitamin K (phylloquinone) | 0.0000 | mcg/kg | 0.0000 | mcg/kg |
| Folate, food | 0.0000 | mcg/kg | 0.0000 | mcg/kg |
| Folate, DFE | 0.0000 | mcg/kg | 0.0000 | mcg/kg |
| Betaine | 0.0000 | mg/kg | 0.0000 | mg/kg |
| Alanine | 0.0000% | | 0.0000% | |
| Aspartic acid | 0.0000% | | 0.0000% | |
| Glutamic acid | 0.0000% | | 0.0000% | |
| Glycine | 0.0000% | | 0.0000% | |
| Proline | 0.0000% | | 0.0000% | |
| Serine | 0.0000% | | 0.0000% | |
| Hydroxyproline | 0.0000% | | 0.0000% | |
| Vitamin E, added | 0.0000 | mg/kg | 0.0000 | mg/kg |
| Vitamin B-12, added | 0.0000 | mcg/kg | 0.0000 | mcg/kg |
| Cholesterol | 0.0000 | mg/kg | 0.0000 | mg/kg |
| Fatty acids, total trans | 0.0000% | | 0.0000% | |
| Fatty acids, total saturate | 0.0000% | | 0.0000% | |
| 4:0 | 0.0000% | | 0.0000% | |
| 6:0 | 0.0000% | | 0.0000% | |
| 8:0 | 0.0000% | | 0.0000% | |
| 10:0 | 0.0000% | | 0.0000% | |
| 12:0 | 0.0000% | | 0.0000% | |
| 14:0 | 0.0000% | | 0.0000% | |
| 16:0 | 0.0000% | | 0.0000% | |
| 18:0 | 0.0000% | | 0.0000% | |
| 20:0 | 0.0000% | | 0.0000% | |
| 18:1 undifferentiated | 0.0000% | | 0.0000% | |
| 22:0 | 0.0000% | | 0.0000% | |
| 14:1 | 0.0000% | | 0.0000% | |
| 16:1 undifferentiated | 0.0000% | | 0.0000% | |
| 18:4 | 0.0000% | | 0.0000% | |
| 20:1 | 0.0000% | | 0.0000% | |
| 22:1 undifferentiated | 0.0000% | | 0.0000% | |
| 22:5 n-3 (DPA) | 0.0000% | | 0.0000% | |
| Phytosterols | 0.0000 | mg/kg | 0.0000 | mg/kg |
| Stigmasterol | 0.0000 | mg/kg | 0.0000 | mg/kg |
| Campesterol | 0.0000 | mg/kg | 0.0000 | mg/kg |
| Beta-sitosterol | 0.0000 | mg/kg | 0.0000 | mg/kg |
| Fatty acids, total monoun | 0.0000% | | 0.0000% | |
| Fatty acids, total polyuns | 0.0000% | | 0.0000% | |
| 15:0 | 0.0000% | | 0.0000% | |
| 17:0 | 0.0000% | | 0.0000% | |
| 24:0 | 0.0000% | | 0.0000% | |
| 16:1 t | 0.0000% | | 0.0000% | |
| 18:1 t | 0.0000% | | 0.0000% | |
| 22:1 t | 0.0000% | | 0.0000% | |
| 18:2 t not further defined | 0.0000% | | 0.0000% | |
| 18:2 i | 0.0000% | | 0.0000% | |
| 18:2 t, t | 0.0000% | | 0.0000% | |
| 18:2 CLAs | 0.0000% | | 0.0000% | |
| 24:1 c | 0.0000% | | 0.0000% | |
| 20:2 n-6 c, c | 0.0000% | | 0.0000% | |
| 16:1 c | 0.0000% | | 0.0000% | |
| 18:1 c | 0.0000% | | 0.0000% | |
| 18:2 n-6 c, c | 0.0000% | | 0.0000% | |
| 22:1 c | 0.0000% | | 0.0000% | |
| 18:3 n-6 c, c, c | 0.0000% | | 0.0000% | |
| 17:1 | 0.0000% | | 0.0000% | |
| 20:3 undifferentiated | 0.0000% | | 0.0000% | |
| Fatty acids, total trans-m | 0.0000% | | 0.0000% | |
| Fatty acids, total trans-po | 0.0000% | | 0.0000% | |
| Omega-6 Fas | 0.0000% | | 0.0000% | |
| 13:0 | 0.0000% | | 0.0000% | |
| 15:1 | 0.0000% | | 0.0000% | |
| 18:3 n-3 c, c, c (ALA) | 0.0000% | | 0.0000% | |
| 20:3 n-3 | 0.0000% | | 0.0000% | |
| 20:3 n-6 | 0.0000% | | 0.0000% | |
| 20:4 n-6 | 0.0000% | | 0.0000% | |
| 18:3i | 0.0000% | | 0.0000% | |
| 21:5 | 0.0000% | | 0.0000% | |
| 22:4 | 0.0000% | | 0.0000% | |
| 18:1-11 t (18:1t n-7) | 0.0000% | | 0.0000% | |
| Starch | 0.0000% | | 0.0000% | |
| Sucrose | 0.0000% | | 0.0000% | |
| Glucose (dextrose) | 0.0000% | | 0.0000% | |
| Fructose | 0.0000% | | 0.0000% | |
| Lactose | 0.0000% | | 0.0000% | |
| Maltose | 0.0000% | | 0.0000% | |
| Alcohol, ethyl | 0.0000% | | 0.0000% | |
| Adjusted Protein | 0.0000% | | 0.0000% | |
| Caffeine | 0.0000 | mg/kg | 0.0000 | mg/kg |
| Theobromine | 0.0000 | mg/kg | 0.0000 | mg/kg |
| Sugars, total | 0.0000% | | 0.0000% | |
| Galactose | 0.0000% | | 0.0000% | |
| Fluoride | 0.0000 | mcg/kg | 0.0000 | mcg/kg |
| Carotene, alpha | 0.0000 | mcg/kg | 0.0000 | mcg/kg |
| Cryptoxanthin, beta | 0.0000 | mcg/kg | 0.0000 | mcg/kg |

### Example 3. Composition and Nutritional Analysis of an Animal Dinner Food

The ingredients of an animal dinner food is shown below in Table 5, and the nutritional value of an animal dinner food is shown in Table 6.

TABLE 5

| Ingredient | % As Fed |
|---|---|
| Yeast Blend | 30.213 |
| 12014 Pumpkin & Squash | 15.106 |
| 12006 Quinoa, ckd | 13.428 |
| 11486 Squash, Wntr, Butter | 10.071 |
| 20130 Barley Flour or Mea | 8.057 |
| Sunflower Seeds, Whole | 5.035 |
| Yeast Extract - Only BOT | 3.021 |
| Carrots, Raw | 3.021 |
| 11143 Celery, Raw | 3.021 |
| Icelandic Rockweed Pow | 0.504 |
| Kale Powder, Sprouted | 1.761 |
| Broccoli Powder, Sprouted | 1.511 |
| Premix Blend | 1.128 |
| 09078 Cranberries, Raw | 1.007 |
| 11457 Spinach, Raw | 1.007 |
| 02029 Parsley, Dried | 0.504 |
| 02038 Sage, Ground | 0.504 |
| Salt, Table | 0.312 |
| Algae Powder - 30% DHA | 0.279 |
| Choline Chloride - ADM | 0.261 |
| Vita-D Yeast | 0.006 |
| Camelina Oil | 0.242 |
| Total | 100.00 |

TABLE 6

| Nutrient | As Fed | | Dry M | |
|---|---|---|---|---|
| Energy | 1971.428 | kcal/kg | 2797.790 | kcal/kg |
| Protein | 23.103% | | 32.787% | |
| Arginine | 1.039% | | 1.475% | |
| Histidine | 0.193% | | 0.275% | |
| Isoleucine | 0.320% | | 0.455% | |
| Leucine | 0.570% | | 0.809% | |
| Lysine | 0.319% | | 0.453% | |
| Methionine | 0.151% | | 0.214% | |
| Methionine + Cystine | 0.257% | | 0.365% | |
| Phenylalanine | 0.411% | | 0.583% | |
| Phelylalanine + Tyrosine | 0.658% | | 0.934% | |
| Threonine | 0.262% | | 0.372% | |
| Tryptophan | 0.131% | | 0.186% | |
| Valine | 0.392% | | 0.556% | |
| Total Lipid (Fat) | 12.910% | | 18.322% | |
| Linoleic acid | 4.536% | | 6.438% | |
| Alpha-linolenic acid | 0.151% | | 0.214% | |
| Arachidonic acid | 0.022% | | 0.031% | |
| 22:6 n-3 (DHA) | 0.086% | | 0.121% | |
| 20:5 n-3 (EPA) | 0.001% | | 0.002% | |
| EPA + DHA | 0.090% | | 0.127% | |
| Omega 6 FA | 4.558% | | 6.469% | |
| Omega 3 FA | 0.241% | | 0.341% | |
| Omega 3 Fas | 0.157% | | 0.223% | |
| Calcium | 1.063% | | 1.508% | |
| Phosphorus | 0.707% | | 1.003% | |
| Potassium | 0.893% | | 1.267% | |
| Magnesium | 0.202% | | 0.287% | |
| Sodium | 0.157% | | 0.223% | |
| Chloride | 0.121% | | 0.172% | |
| Iron | 86.149 | mg/kg | 122.260 | mg/kg |
| Copper | 18.172 | mg/kg | 25.790 | mg/kg |
| Manganese | 21.345 | mg/kg | 30.292 | mg/kg |
| Zinc | 121.127 | mg/kg | 171.900 | mg/kg |
| Iodine | 5.542 | mg/kg | 7.865 | mg/kg |
| Selenium | 358.674 | mcg/kg | 509.020 | mcg/kg |
| Vitamin A, IU | 32570.603 | IU/kg | 46223.198 | IU/kg |
| Vitamin D | 503.549 | IU/kg | 714.621 | IU/kg |
| Vitamin E (alpha-tocopherol) | 71.279 | mg/kg | 101.157 | mg/kg |
| Thiamin | 8.100 | mg/kg | 11.495 | mg/kg |
| Riboflavin | 7.257 | mg/kg | 10.299 | mg/kg |
| Pantothenic acid | 17.203 | mg/kg | 24.414 | mg/kg |
| Niacin | 47.820 | mg/kg | 67.865 | mg/kg |
| Vitamin B-6 | 4.057 | mg/kg | 5.757 | mg/kg |
| Folic acid | 451.180 | mcg/kg | 640.300 | mcg/kg |
| Vitamin B-12 | 28.199 | mcg/kg | 40.019 | mcg/kg |
| Choline, total | 1369.653 | mg/kg | 1943.769 | mg/kg |
| Taurine | 0.000% | | 0.000% | |
| Carnitine | 0.000 | mg/kg | 0.000 | mg/kg |
| Carbohydrate, by differen | 27.518% | | 39.053% | |
| Fiber, total dietary | 4.954% | | 7.030% | |
| Water | 27.883% | | 39.571% | |
| Ash | 4.318% | | 6.129% | |
| Energy KJ | 7.000 | MJ/kg | 9.934 | MJ/kg |
| Vitamin D (D2 + D3 | 0.000 | mcg/kg | 0.000 | mcg/kg |
| Cystine | 0.105% | | 0.149% | |
| Tyrosine | 0.246% | | 0.349% | |
| Vitamin D2 (ergocalcifero | 0.000 | mcg/kg | 0.000 | mcg/kg |
| Vitamin A, RAE | 891.181 | mcg/kg | 1264.736 | mcg/kg |
| Carotene, beta | 8023.799 | mcg/kg | 11387.129 | mcg/kg |
| Vitamin D3 (cholecalcifer | 0.000 | mcg/kg | 0.000 | mcg/kg |
| Lycopene | 0.302 | mcg/kg | 0.429 | mcg/kg |
| Retinol | 0.000 | mcg/kg | 0.000 | mcg/kg |
| Lutein + zeaxanthin | 1930.022 | mcg/kg | 2739.027 | mcg/kg |
| Tocopherol, beta | 0.684 | mg/kg | 0.970 | mg/kg |
| Tocopherol, gamma | 54.907 | mg/kg | 77.923 | mg/kg |
| Tocopherol, delta | 0.822 | mg/kg | 1.167 | mg/kg |
| Tocotrienol, alpha | 0.006 | mg/kg | 0.009 | mg/kg |
| Tocotrienol, beta | 0.000 | mg/kg | 0.000 | mg/kg |
| Tocotrienol, gamma | 0.120 | mg/kg | 0.170 | mg/kg |
| Tocotrienol, delta | 0.000 | mg/kg | 0.000 | mg/kg |
| Vitamin C, total ascorbic | 33.667 | mg/kg | 47.780 | mg/kg |
| Folate, total | 343.020 | mcg/kg | 486.803 | mcg/kg |
| Menaquinone-4 | 0.000 | mcg/kg | 0.000 | mcg/kg |
| Dihydrophylloquinone | 0.000 | mcg/kg | 0.000 | mcg/kg |
| Vitamin K (phylloquinone) | 246.772 | mcg/kg | 350.211 | mcg/kg |
| Folate, food | 343.020 | mcg/kg | 486.803 | mcg/kg |
| Folate, DFE | 343.020 | mcg/kg | 486.803 | mcg/kg |
| Betaine | 81.187 | mg/kg | 115.218 | mg/kg |
| Alanine | 0.357% | | 0.507% | |
| Aspartic acid | 0.710% | | 1.007% | |
| Glutamic acid | 1.568% | | 2.225% | |
| Glycine | 0.428% | | 0.607% | |
| Proline | 0.408% | | 0.579% | |
| Serine | 0.379% | | 0.538% | |
| Hydroxyproline | 0.000% | | 0.000% | |
| Vitamin E, added | 0.000 | mg/kg | 0.000 | mg/kg |
| Vitamin B-12, added | 0.000 | mcg/kg | 0.000 | mcg/kg |
| Cholesterol | 0.000 | mg/kg | 0.000 | mg/kg |
| Fatty acids, total trans | 0.010% | | 0.014% | |
| Fatty acids, total saturate | 1.638% | | 2.324% | |
| 4:0 | 0.000% | | 0.000% | |
| 6:0 | 0.000% | | 0.000% | |
| 8:0 | 0.004% | | 0.005% | |
| 10:0 | 0.004% | | 0.006% | |
| 12:0 | 0.003% | | 0.004% | |
| 14:0 | 0.015% | | 0.021% | |
| 16:0 | 0.997% | | 1.415% | |
| 18:0 | 0.528% | | 0.749% | |
| 20:0 | 0.038% | | 0.054% | |
| 18:1 undifferentiated | 3.454% | | 4.901% | |
| 22:0 | 0.025% | | 0.035% | |
| 14:1 | 0.000% | | 0.000% | |
| 16:1 undifferentiated | 0.009% | | 0.013% | |
| 18:4 | 0.001% | | 0.001% | |
| 20:1 | 0.017% | | 0.024% | |
| 22:1 undifferentiated | 0.005% | | 0.007% | |
| 22:5 n-3 (DPA) | 0.000% | | 0.000% | |
| Phytosterols | 283.901 | mg/kg | 402.903 | mg/kg |
| Stigmasterol | 0.000 | mg/kg | 0.000 | mg/kg |
| Campesterol | 0.000 | mg/kg | 0.000 | mg/kg |
| Beta-sitosterol | 0.000 | mg/kg | 0.000 | mg/kg |
| Fatty acids, total monoun | 3.490% | | 4.952% | |
| Fatty acids, total polyuns | 4.577% | | 6.496% | |
| 15:0 | 0.001% | | 0.002% | |
| 17:0 | 0.007% | | 0.009% | |
| 24:0 | 0.011% | | 0.015% | |
| 16:1 t | 0.000% | | 0.000% | |
| 18:1 t | 0.004% | | 0.005% | |
| 22:1 t | 0.000% | | 0.000% | |
| 18:2 t not further defined | 0.006% | | 0.008% | |
| 18:2 i | 0.000% | | 0.000% | |
| 18:2 t, t | 0.000% | | 0.000% | |
| 18:2 CLAs | 0.001% | | 0.001% | |
| 24:1 c | 0.001% | | 0.001% | |
| 20:2 n-6 c, c | 0.001% | | 0.001% | |
| 16:1 c | 0.007% | | 0.010% | |
| 18:1 c | 2.437% | | 3.459% | |
| 18:2 n-6 c, c | 3.128% | | 4.440% | |
| 22:1 c | 0.000% | | 0.000% | |
| 18:3 n-6 c, c, c | 0.000% | | 0.000% | |
| 17:1 | 0.001% | | 0.001% | |
| 20:3 undifferentiated | 0.000% | | 0.000% | |
| Fatty acids, total trans-m | 0.004% | | 0.006% | |
| Fatty acids, total trans-po | 0.006% | | 0.008% | |
| Omega-6 Fas | 4.557% | | 6.467% | |
| 13:0 | 0.000% | | 0.000% | |
| 15:1 | 0.000% | | 0.000% | |
| 18:3 n-3 c, c, c (ALA) | 0.027% | | 0.039% | |
| 20:3 n-3 | 0.000% | | 0.000% | |
| 20:3 n-6 | 0.000% | | 0.000% | |
| 20:4 n-6 | 0.000% | | 0.000% | |
| 18:3i | 0.000% | | 0.000% | |
| 21:5 | 0.000% | | 0.000% | |
| 22:4 | 0.001% | | 0.001% | |
| 18:1-11 t (18:1t n-7) | 0.000% | | 0.000% | |
| Starch | 2.633% | | 3.736% | |
| Sucrose | 0.430% | | 0.611% | |
| Glucose (dextrose) | 0.099% | | 0.141% | |
| Fructose | 0.061% | | 0.086% | |
| Lactose | 0.000% | | 0.000% | |
| Maltose | 0.000% | | 0.000% | |
| Alcohol, ethyl | 0.000% | | 0.000% | |
| Adjusted Protein | 0.000% | | 0.000% | |
| Caffeine | 0.000 | mg/kg | 0.000 | mg/kg |
| Theobromine | 0.000 | mg/kg | 0.000 | mg/kg |
| Sugars, total | 0.999% | | 1.418% | |
| Galactose | 0.016% | | 0.022% | |
| Fluoride | 2.238 | mcg/kg | 3.176 | mcg/kg |
| Carotene, alpha | 2190.891 | mcg/kg | 3109.245 | mcg/kg |
| Cryptoxanthin, beta | 3145.317 | mcg/kg | 4463.737 | mcg/kg |

### Example 4. Dog Food Composition

A nutritionally complete animal-free dog food was developed. The composition is detailed in Table 7.

TABLE 7

| Table 4 | | |
|---|---|---|
| Ingredient | % | g |
| Yeast Blend | 36% | 142.76 |
| Oats | 15.81% | 62.59 |
| Sweet potato | 12% | 48.95 |
| Chia seeds | 8% | 32.63 |
| Pumpkin seeds | 10% | 40.79 |
| Sunflower seeds | 5% | 20.39 |
| Apples | 3% | 12.24 |
| Bananas | 3% | 12.24 |
| Coconut flour | 3% | 11.83 |
| Vitamin Blend | 2% | 6.71 |
| (Complete Vitamin Blend for Dogs) | | |
| Salt | 0% | 1.26 |
| Camelina oil | 0% | 1.22 |
| DSM DHA Gold | 0% | 1.31 |
| Choline | 0% | 1.14 |
| TOTALS | 100% | 396 |

### Example 5. Dog Food Acceptability Test

A dog food acceptability test is performed. Eight dogs are carefully selected for the study (additional dogs may be included, as an option, a minimum of eight is recommended). Dogs selected are of mixed breeds, age, temperament and sex to approximate actual market conditions. Selected dogs are known to be healthy, accept dry kibble, and have regular stools. Pets and owners are selected for the study with the specific goal of achieving test results (e.g., owners with multiple pets may not be selected, since it could be difficult to determine stools produced by each pet).

One dog food formula is tested in this trial. Owners are trained to feed, examine and collect feces from their pets and record observations on data collection forms. Feces samples are recovered prior to, and at end of the test period for microbiome analyses. Feces samples are mailed to a third-party labs for microbiome analysis. An average of 2 cups of each product is needed per dog per day. There is an acclimation period of 5 days that will require approximately 1.25 cup/day.

Test objectives are: 1) provide a visual record of the condition of the pet's stool (photograph); 2) provide a record of the pet's interest in the product (owner survey); 3) survey pet owners to determine their opinion of the condition of the pet's stool, acceptability of the diet (transition issues), and of the product in general; 4) collect stool samples (pretest and end of test) and mail to a third-party laboratory for microbiome analysis (stool samples are collected by pet owners, using supplied materials and a prepaid mailer); and 5) collect stool samples (for five days during test) and analyze composite samples to estimate energy assimilation and mass balance. The dogs are exclusively fed the product for at least 28 days (after acclimation). Use of other foods and during the testing period is prohibited.

Information collected is compiled and analyzed. A technical report is written and provided to the inventors. The data is evaluated both qualitatively and quantitatively (i.e., use of appropriate statistical test). A follow-up interview is conducted to identify project strengths, weaknesses, and improvement methods. Proposals for future activities are presented.

The following scope is studied: 1) acceptability trial for one dog food. The inventor is blinded to trial participants; 2) feces is collected for microbiome analysis (two samples, mailed to outside laboratory) Samples are collected at or near day 0, and end of the study; 3) feces is collected and processed for energy assimilation and mass balance. Energy loss through urine is estimated. Collection of feces samples occurs between the middle and end of the trial; 4) veterinarian visits for pets at, or near, days 0 and end of the study for: blood and urine analyses and a wellness check. A parasite screening occurs at day 0. Pets with parasites are treated or removed from the study (and replaced with an alternate).

All of the compositions and/or methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and/or methods and in the steps or in the sequence of steps of the method described herein without departing from the concept, spirit and scope of the disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims. All such similar substitutes and modifications apparent to those skilled in the art are deemed to be within the spirit, scope and concept of the disclosure as defined by the appended claims.

What is claimed is:

1. An animal food composition that comprises at least 25% yeast product and at least 1% Aspergillus product.

2. The animal composition food of claim 1, wherein the animal food composition comprises less than 1% of protein derived from an animal source.

3. The animal food composition of claim 1, wherein the animal food composition comprises less than 1% of protein derived from mammalian or insect sources.

4. The animal food composition of claim 1, wherein the yeast product is a deactivated yeast.

5. The animal food composition of claim 1, wherein the yeast product comprises Saccharomyces cerevisiae.

6. The animal food composition of claim 1, wherein the yeast product is dried yeast.

7. The animal food composition of claim 1, wherein the yeast product and the Aspergillus sp. product are powdered forms of the yeast product and the Aspergillus sp. product.

8. The animal food composition of claim 1, wherein the Aspergillus sp. product comprises Aspergillus niger.

9. The animal food composition of claim 1, wherein the Aspergillus sp. product is a koji mold comprising an Aspergillus sp.

10. The animal food of claim 1, wherein the animal food composition comprises at least about 10% protein content from the yeast product and the Aspergillus product.

11. The animal food composition of claim 10, wherein the animal food composition comprises at least about 15% protein content which is from said yeast product and Aspergillus product.

12. The animal food composition of claim 1, wherein the animal food composition comprises a cylindrical shape, a rectangular shape, a cuboid shape, a triangular shape, a circular shape, an elliptical shape, a polygonal shape, a polyhedral shape, or an irregular shape.

13. The animal food composition of claim 1, wherein the animal food composition comprises a form and size suitable for consumption by a cat.

14. The animal food composition of claim 13, wherein the animal food composition comprises a length of about ½ or ⅜ inch, width of about ½ or ⅜ inch, and a thickness of about ½ or ⅜ inch.

15. The animal food composition of claim 1, wherein the animal food composition comprises a form and size suitable for consumption by a dog.

16. The animal food composition of claim 15, wherein the animal food composition comprises a length of about 1 inch, a width of about ½ inch, and a thickness of ⅜ inch.

17. The animal food composition of claim 1, wherein the animal food composition comprises a nutritional profile similar to a meat-based animal food.

18. A method of preparing an animal food composition, the method comprising:
a) forming a paste comprising a yeast product and an Aspergillus sp. product by hydrating a dry yeast product and a dry Aspergillus sp. product with a fluid;
b) shaping the paste to form a shaped paste; and
c) freeze-drying the shaped paste.

19. The method of claim 18, wherein the ratio of the dry yeast product and the dry Aspergillus sp. product to the fluid is about 5:1.

20. A method of feeding an animal, the method comprising feeding the animal food composition of claim 1 to the animal, wherein the animal food composition maintains or improves gut health and immunity.
